(19) United States
(12) Patent Application Publication
(10) Pub. No.: US 2026/0163882 A1
(43) Pub. Date: Jun. 11, 2026

(54) COMPARISON OF BIOMETRIC DATA IN THE ENCRYPTED DOMAIN

(71) Applicant: IDEMIA PUBLIC SECURITY FRANCE, Courbevoie (FR)

(72) Inventor: Hervé CHABANNE, Courbevoie (FR)

(73) Assignee: IDEMIA PUBLIC SECURITY FRANCE, Courbevoie (FR)

(21) Appl. No.: 19/183,191

(22) Filed: Apr. 18, 2025

(30) Foreign Application Priority Data
Apr. 18, 2024 (FR) FR2404052

(51) Int. Cl. H04L 9/40; H04L 9/06

(52) U.S. Cl. CPC H04L 63/0861; H04L 9/0618

(57) ABSTRACT

A method comprising steps of: computing a cipher of a masked score representing the result of applying a primary mask r to a distance score between a test biometric datum (x) and a reference biometric datum (yᵤ); and for any i ranging from 1 to d, performing the following steps by way of a decryption device of index i: decrypting the cipher of the masked score using a secondary decryption key ( [symbol] sk [symbol] ᵢ) of index i, the decryption producing a datum (ŝ) representing the masked score modulo 2ⁿ, and generating a partial result (oᵢ) of index i from the datum (ŝ) and an unmasking datum (kᵢ) of index i.

### FIELD OF THE INVENTION

This disclosure concerns the comparison of biometric data in the encrypted domain, in particular for identity checking.

### PRIOR ART

A conventional method for checking whether an individual is enrolled in a database comprises the following steps. A test biometric datum relating to the individual to be checked is acquired. Next, a score representative of a distance between the test biometric datum and a reference biometric datum contained in the database is computed. This score is then compared with a threshold. A check result indicating whether or not the test biometric datum matches the reference biometric datum is obtained at the end of this comparison.

Ibarrondo, Alberto, et al. “Colmade: Collaborative masking in auditable decryption for bfv-based homomorphic encryption.” Proceedings of the 2022 ACM Workshop on Information Hiding and Multimedia Security, 2022, describes a method that uses this general principle, but with the following particularities. First, the Colmade method computes the score and compares it with a threshold in the encrypted domain. Secondly, the Colmade method comprises centralized steps, and steps distributed over multiple entities: these entities perform parallel computations producing partial results, these partial results then having to be recombined in order to arrive at the check result.

However, the execution time of the Colmade method is long.

In particular, a fairly expensive operation in terms of homomorphic encryption is multiplication.

Bassit, Amina, et al. “Multiplication-free biometric recognition for faster processing under encryption.” 2022 IEEE International Joint Conference on Biometrics (IJCB). IEEE, 2022 proposes computing the cipher of the score by using precomputed look-up tables. The mathematical function f for computing the cipher of the score is the sum of subfunctions ƒ₁, . . . , ƒ_{d}. The different look-up tables used represent these subfunctions. Thus, to obtain the cipher of the score, it suffices to determine d portions of the cipher by searching the d look-up tables, then to sum these d portions. Since this processing uses only tables and additions, it is very light in terms of computational load.

However, this solution is not entirely satisfactory.

First, this solution is implemented in a system comprising a service provider (SP) possessing a decryption key sk and a storage server (DB) storing ciphers of reference biometric data that has no knowledge of the decryption key sk. The storage server sends back to the service provider the cipher of information indicating whether a test biometric datum matches a reference biometric datum, and the service provider decrypts this cipher using its decryption key s k. Now, if there is collusion between SP (which possesses sk) and the storage server DB (which has the ciphers of the reference biometric data), the basis formed by the ciphers of the reference biometric data can be revealed.

Secondly, the first solution proposed has thresholding that can be used in the encrypted domain, openly, and is therefore not very efficient. The second alternative solution proposed has thresholding that is performed after decryption, and therefore in plaintext form. This leads to a security problem and is therefore unsatisfactory.

### SUMMARY OF THE INVENTION

An aim of the invention is to check whether an individual is enrolled in a database without requiring excessive execution time and in a secure manner.

This aim is achieved by a method comprising steps of:
computing a cipher of a masked score, the masked score representing the result of applying a primary mask r to a score representing a distance between a test biometric datum x relating to an individual and a reference biometric datum yᵤ, the computation comprising:
   for any j ranging from 1 to k and for any i ranging from 1 to d, with k≥1 and d≥2, determining, in a precomputed look-up table, a term equal to (T_{i,j}+ [symbol] r [symbol] _{i,j}) mod 2ⁿ matching a pair consisting of a portion of the test biometric datum x and a portion of a cipher c_{y}_{ᵤ} of the reference biometric datum, where:
      the cipher of the reference biometric datum c_{y}_{ᵤ} results from an encryption of the reference biometric datum yᵤ using a primary encryption key pk,
      n is a predefined integer,
      a sum

$$( {\sum }_{i = 1}^{d} {\sum }_{j = 1}^{k} {T}_{i , j} ) mod {2}^{n}$$

of the tables T_{i,j} constitutes an estimate of a cipher of the score in unmasked form,
the primary mask r is connected to secondary masks [symbol] r [symbol] _{i,j} by the following relationship:

$$( {\sum }_{i = 1}^{d} {\sum }_{j = 1}^{k} {〈 r 〉}_{i , j} ) mod {2}^{n} = r mod {2}^{n} ,$$

performing the following summation in order to obtain the cipher of the masked score:

$${\sum }_{i = 1}^{d} {\sum }_{j = 1}^{k} ( {T}_{i , j} + {〈 r 〉}_{i , j} ) mod {2}^{n} ;$$

for any i ranging from 1 to d, performing the following steps by way of a decryption device of index i:
   decrypting the cipher of the masked score using a secondary decryption key ( [symbol] sk [symbol] ᵢ) of index i, the decryption producing a datum s representing the masked score modulo 2ⁿ,
   generating a partial result oᵢ of index i from the datum s and an unmasking datum kᵢ of index i,
wherein:
   the secondary decryption keys [symbol] sk [symbol] ₁, . . . , [symbol] sk [symbol] _{d} of respective indices ranging from 1 to d stem from a primary decryption key sk associated with the encryption key pk,
   the partial results o₁, . . . , o_{d} of respective indices ranging from 1 to d make it possible to compute a check result o indicating whether or not the test biometric datum x matches the reference biometric datum.

In the proposed method, the decryption of the cipher of the masked score, which takes place at the same time as the generation of the partial result, which is representative of the comparison with a threshold, is distributed between multiple decryption devices of index i. This reduces the risk of collusion.

The proposed method may also comprise the following optional features, taken alone or in combination whenever possible:
determining the term (T_{i,j}+ [symbol] r [symbol] _{i,j})mod 2ⁿ comprises the following steps:
   determining, in a first look-up table of index i, a pointer of index i matching the pair, the pointer of index i pointing to a position, in a second table of 2ⁿ terms, where the term of index i is stored,
   determining the term of index i in the second table using the pointer of index i;
the method additionally comprises steps of:
   permutating the second table, then.
   repeating the computation of the cipher of the masked score for a new test biometric datum;
it holds that k>1, for any j ranging from 1 to k and for any i ranging from 1 to d, the determination of the term equal to (T_{i,j}+ [symbol] r [symbol] _{i,j})mod 2ⁿ is performed by a storage server 2 of index j, for any j ranging from 1 to k, the server of index j computes a portion of index j of the cipher of the masked score by way of the following summation:

$${\sum }_{i = 1}^{d} ( {T}_{i , j} + {〈 r 〉}_{i , j} ) mod {2}^{n} ,$$

and for any i ranging from 1 to d, the decryption device of index i computes the cipher of the masked score by summing the portions of respective indices ranging from 1 to k of the cipher of the masked score;
it holds that k=1 and the computation of the cipher of the masked score is performed by a single storage server;
the decryption performed by the decryption device of index i comprises the following steps:
   computing an intermediate datum [symbol] c_{ŝ}_{_{b}} [symbol] ᵢ of index i from the following data:
      a first part cₛ_{_{b}} of the cipher of the masked score,
      the secondary decryption key [symbol] sk [symbol] ᵢ of index i, and
      a random quantity eᵢ generated by the decryption device of index i,
   for any decryption device of index jai, receiving an intermediate datum [symbol] c_{ŝ}_{_{b}} [symbol] ⱼ of index j sent by the decryption device of index j,
   computing the datum s representing the masked score from the following data:
      the intermediate data [symbol] c_{ŝ}_{_{b}} [symbol] ₁, . . . , [symbol] c_{ŝ}_{_{b}} [symbol] _{d} of respective indices ranging from 1 to d,
      a second part cₛ_{ₐ} of the cipher of the masked score;
the intermediate datum [symbol] c_{ŝ}_{_{b}} [symbol] ᵢ of index i is computed as follows:

$${〈 {c}_{{\hat{s}}_{b}} 〉}_{i} = {c}_{{s}_{b}} {〈 sk 〉}_{i} + {e}_{i}$$

wherein cₛ_{_{b}} is the first part of the cipher cₛ of the masked score, [symbol] sk [symbol] ᵢ is the secondary decryption key of index i, and eᵢ is the random quantity generated by the device of index i;
the datum ŝ representing the masked score modulo 2ⁿ is computed as follows:

$${\hat{s} = [ ⌊ {\frac{t}{q} [ {c}_{{s}_{a}} + {\sum }_{i = 1}^{d} {〈 {c}_{{\hat{s}}_{b}} 〉}_{i} ]}_{q} ⌉ ]}_{t} mod {2}^{n}$$

wherein [symbol] c_{ŝ}_{_{b}} [symbol] ᵢ is the intermediate datum of index i, cₛ_{ₐ} is the second part of the cipher (cₛ) of the score, t and q are two integers constituting parameters of a Brakerski/Fan-Vercauteren encryption scheme, └·┐ signifies the operator for rounding to the nearest integer, [·]_{q} signifies the modulo q operator, [·]ₜ signifies the modulo t operator.
the check result o is equal to the sum of the partial results o₁, . . . , o_{d} of respective indices ranging from 1 to d;
at least one of the following data is a single-use datum for the test biometric datum x, or even for the cipher of the masked score:
   the unmasking datum of index i,
   the secondary decryption key of index i.

This disclosure also concerns a computer program product comprising program code instructions for carrying out the steps of the method described above when this program is executed by a system.

This disclosure also concerns a computer-readable memory storing instructions that are executable in order to carry out the steps of the method described above.

In another aspect, this disclosure concerns a system comprising a control device, a storage server, at least two decryption devices, a trusted server and an enrollment device, wherein said devices and servers include processors configured to perform the steps of the method described above.

The method described above can be performed by way of a method for controlling access by an individual to a secure area in order to identify the individual.

### DESCRIPTION OF THE FIGURES

Further features, aims and advantages of the invention will become apparent from the following description, which is purely illustrative and non-limiting, and which should be read with reference to the appended drawings, in which:

FIG. 1 schematically illustrates interactions between various devices forming part of a system according to one embodiment, which is able to be used to check the identity of individuals.

FIG. 2 schematically illustrates various devices forming part of a system according to one embodiment.

FIG. 3 is a flowchart of steps of a method according to one implementation.

In all of the figures, elements that are similar have been designated by identical references.

### DETAILED DESCRIPTION OF THE INVENTION

In the description that follows, the following conventions are adopted:
A cipher of a datum represents the result of an encryption applied to the datum.
A masked datum represents the result of a masking applied to that datum.
By combining the above two principles, the “cipher of a masked datum” represents the result of an encryption applied to a masked datum, this masked datum itself representing the result of a masking applied to the datum.
A modulo 2ⁿ summation of terms is an operation comprising a summation of the terms, followed by the application of the modulo 2ⁿ operator to the sum obtained.

### System for Checking the Identity of an Individual

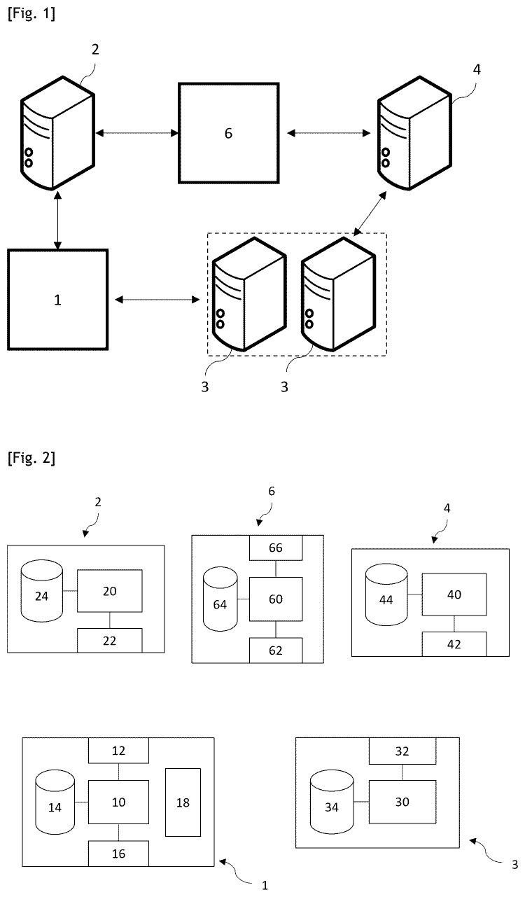

Referring to FIGS. 1 and 2, a system comprises a control device 1, at least one storage server 2, at least two decryption devices 3, a trusted server 4 and an enrollment device 6.

The number of storage servers 2 of the system is denoted by k, with k≥1. By convention, the silent index j will be used to signify one or other of the storage servers 2.

The number of decryption devices 3 is furthermore denoted by d, with d≥2. By convention, the silent index i will be used to signify one or other of the decryption devices 3.

The control device 1 comprises a processor 10, a communication interface 12 for communicating with the storage server 2, a memory 14 and a biometric sensor 16.

The processor 10 is configured to implement some steps of a method that will be described later. The processor 10 may have any structure. The processor 10 comprises one or more cores, each core being configured to execute the code instructions of a program so as to perform the aforementioned steps.

The communication interface 12 is for example of wireless radio type, and uses any communication protocol (Wi-Fi, Bluetooth, etc.).

The memory 14 is designed to store data manipulated or produced by the processor 10. The memory 14 is of any type. Conventionally, the memory 14 comprises a volatile memory for storing data temporarily, and a non-volatile memory for storing data persistently, that is to say in a manner that preserves the data when the non-volatile memory is turned off.

The biometric sensor 16 is configured to acquire biometric data relating to individuals. For example, the biometric sensor 16 comprises a camera configured to acquire images showing the face of an individual, and to extract biometric data from such images. As an alternative or in addition, the biometric sensor 16 comprises a fingerprint sensor and/or an iris sensor.

In one embodiment, the control device 1 additionally comprises a gate 18 that can be closed in order to prevent an individual from accessing a secure area, and can be opened in order to allow such access. The processor 10 is in this case configured to control the opening and closing of the gate 18. For example, the control device 1 is located in an airport, and the secure area is a boarding area; in this specific application, the individuals wishing to access the boarding area are the passengers on a flight, whose identity needs to be checked before boarding.

FIG. 1 shows a single storage server 2, but this is only an example. Each storage server 2 comprises a processor 20, a communication interface 22 for communicating with the control device 1, and a memory 24. The information provided above with regard to the processor 10 and the communication interface 12 can also be applied to the processor 20 and to the communication interface 22.

The memory 24 stores a biometric database containing confidentiality-protected biometric data. Biometric data relating to previously enrolled individuals are referenced in the database. The biometric data of an enrolled individual are not in plaintext form in the database, but are by contrast confidentiality-protected, that is to say have an encrypted form, by virtue of a homomorphic encryption.

The memory 24 furthermore stores precomputed look-up tables, making it possible to obtain the result of a mathematical function applied to input data (this mathematical function will be described in greater detail hereinafter). It should be noted that the expression “look-up table” must be understood as any set of organized data allowing matches between the antecedents and the images of this mathematical function to be established without computation.

Each decryption device 3 comprises a processor 30, a communication interface 32 for communicating with the control device 1 and/or the other decryption devices 3, and a memory 34. The information provided above with regard to the processor 10 and the communication interface 12 can also be applied to the processor 30 and to the communication interface 32. The communications between the interfaces 12, 22 and the communications between the interfaces 12, 32 may use identical or else different protocols.

The decryption devices 3 are distinct from one another. Hereinafter, a detailed description will be given of an embodiment in which the decryption devices 3 are distinct from the control device 1, from each storage server 2, from the enrollment device 4 and from the enrollment device 6, as shown in FIG. 1. However, in other embodiments, it may be envisaged for the control device 1, the storage server 2, the enrollment device 4 and/or the enrollment device 6 to be included in one of the decryption devices 3.

The function of the trusted server 4 is to generate cryptographic keys, some of which are used by other components of the system. The trusted device 4 comprises a processor 40, a communication interface 42 for communicating with the enrollment device 6 and with each decryption device 3, and a memory 44. The information provided above with regard to the processor 10, the communication interface 12 and the memory 14 can also be applied to the processor 40, the communication interface 42 and the memory 44.

The enrolment device 6 comprises a processor 60, a communication interface 62 for communicating with the trusted server 4 and with the storage server 2, a memory 64 and a biometric sensor 66. The information provided above with regard to the processor 10, the communication interface 12, the memory 14 and the biometric sensor 16 can also be applied to the processor 60, the interface 62, the memory 64 and the biometric sensor 66. Hereinafter, a detailed description will be given of an embodiment in which the enrollment device 6 is distinct from the control device 1. However, in other embodiments, the control device 1 could be used as an enrollment device.

### Look-Up Tables

A reference biometric datum will be denoted by yᵤ. It has been seen above that the memory 24 of a storage server 2 stores not the datum yᵤ, but rather a cipher c_{y}_{ᵤ} of this datum. More precisely, the cipher c_{y}_{ᵤ} of the reference biometric datum yᵤ results from an encryption of the reference biometric datum yᵤ using a primary encryption key pk. This is true for each reference biometric datum stored in encrypted form in the storage server(s) 2. The encryption is homomorphic.

A conventional operation consists in computing a score s representative of a distance between a test biometric datum x and a stored reference biometric datum yᵤ. The distance represented by the score is, for example, a scalar product between the test biometric datum x and the reference biometric datum yᵤ.

It is possible to compute a cipher cₛ of the score representative of the distance between the test biometric datum x and the reference biometric datum yᵤ, this while remaining in the domain encrypted using the key pk. In particular, there is a score function f, known to those skilled in the art, which produces this cipher, as explained in Bassit, Amina, et al. “Multiplication-free biometric recognition for faster processing under encryption.” 2022 IEEE International Joint Conference on Biometrics (IJCB). IEEE, 2022. It is thus understood that the cipher cₛ is a score obtained from the data x and c_{y}_{ᵤ} (it will be noted here that the input datum c_{y}_{ᵤ} is already encrypted, whereas x is not). This therefore gives:

$${c}_{s} = f ( x , {c}_{{y}_{u}} )$$

The score function ƒ can itself be broken down into d×k subfunctions ƒ_{i,j} known to those skilled in the art, which observe the following additivity property:

$${c}_{s} = f ( x , {c}_{{y}_{u}} ) = {\sum }_{i = 1}^{d} {\sum }_{j = 1}^{k} {f}_{i , j} ( {p}_{i , j} , {ref}_{i , j} )$$

where:
p_{i,j} is a portion of the input biometric datum x.
ref_{i,j} is a portion of the cipher c_{y}_{ᵤ} of the reference biometric datum yᵤ.

The portions p_{i,j}, ref_{i,j}, were determined upstream by way of a quantification processing operation known from the prior art, for example as described in Bassit, Amina, et al. “Multiplication-free biometric recognition for faster processing under encryption.” 2022 IEEE International Joint Conference on Biometrics (IJCB). IEEE, 2022.

As a reminder, the indices i and j run through the integers from 1 to d, the number of encryption devices 3, and the integers from 1 to k, the number of storage servers 2, respectively.

An advantage of this breakdown is that it is computationally less expensive to go through the subfunctions ƒ_{i,j} before summing their respective images to obtain the score cₛ. In particular, addition is an inexpensive operation.

Let us now suppose that the subfunctions ƒ_{i,j} are replaced with precomputed look-up tables T_{i,j}. From a pair of values p_{i,j}, ref_{i,j}, the table T_{i,j} would be able to provide, through a matching set, the output value ƒ_{i,j} (p_{i,j}, ref_{i,j}). There is therefore one look-up table T_{i,j} per subfunction ƒ_{i,j}. In other words, each table T_{i,j} would provide the following term, constituting a portion of the cipher cₛ:

$${T}_{i , j} ( {p}_{i , j} , {ref}_{i , j} ) \approx {f}_{i , j} ( {p}_{i , j} , {ref}_{i , j} )$$

It would then suffice to sum the d×k portions provided to obtain an estimate of the result of the function f, in other words to obtain the cipher cₛ of the score s, as follows:

$${c}_{s} = f ( x , {c}_{{y}_{u}} ) \approx {\sum }_{i = 1}^{d} {\sum }_{j = 1}^{k} {T}_{i , j} ( {p}_{i , j} , {ref}_{i , j} )$$

With such tables, the computational resources needed to obtain the cipher cₛ of the score s would be further reduced: this is because it is less expensive to search a precomputed look-up table T_{i,j} for an output matching input data than to apply the subfunction ƒ_{i,j} to those same input data.

We will now see that the storage servers 2 store more complex look-up tables S_{i,j} than the tables T_{i,j}, because the tables S_{i,j} incorporate an implicit masking operation of the score s within them.

For any j ranging from 1 to k, the storage server of index j stores d look-up tables S_{1,j}, . . . , S_{i,j} . . . , S_{d,j}. There is therefore, for each storage server 2, a look-up table S_{i,j} for each encryption device 3 of index i.

The aim of the look-up table S_{i,j} is not to obtain a portion of the cipher of the score s representative of a distance between x and yᵤ, as presented above, but to obtain a portion of the cipher of a masked score, this masked score resulting from a masking of the score s using a primary mask r. The cipher of the masked score is denoted by cₛ₊ᵣ.

The look-up table S_{i,j} is built to return the following term, from the portions p_{i,j} and ref_{i,j}:

$${S}_{i , j} ( {p}_{i , j} , {ref}_{i , j} ) = ( {T}_{i , j} ( {p}_{i , j} , {ref}_{i , j} ) + {〈 r 〉}_{i , j} ) mod {2}^{n}$$

where:
n is a predefined integer greater than or equal to 1,
[symbol] r [symbol] _{i,j} is a secondary mask constituting a portion of the primary mask r,
mod signifies the modulo operator.

The secondary masks [symbol] r [symbol] _{i,j} are linked by the following relationship:

$$( {\sum }_{i = 1}^{d} {\sum }_{j = 1}^{k} {〈 r 〉}_{i , j} ) mod {2}^{n} = r mod {2}^{n}$$

Furthermore, in the same spirit as the scenario described above, which does not use masking,

$$( {\sum }_{i = 1}^{d} {\sum }_{j = 1}^{k} {T}_{i , j} ) mod {2}^{n}$$

constitutes an estimate of the cipher cₛ of the score s (in unmasked form).

It should be noted that the modulo 2ⁿ operation is an expensive operation in the encrypted domain. As this operation is integrated in the look-up tables S_{i,j}, it will not have to be applied.

As will be seen below, by summing the d×k terms provided by the tables S_{i,j}, we obtain not the cipher cₛ of the score s, but the cipher c_{s+r.} of the masked score s+r.:

$${c}_{s + r .} = {\sum }_{i = 1}^{d} {\sum }_{j = 1}^{k} {S}_{i , j} ( {p}_{i , j} , {ref}_{i , j} )$$

### Generating Keys, Masks, and Look-Up Tables

The following steps are performed preliminarily within the system.

The processor 40 of the trusted server 4 generates the encryption key pk and an associated decryption key sk, the two keys forming a pair of cryptographic keys, typically a pair of asymmetric keys. The keys are, for example, randomly generated.

The keys pk, sk are stored in the memory 44.

The trusted server 4 sends the enrollment device the encryption key pk, which is therefore a public key. In contrast, the decryption key sk is a private key specific to the trusted server 4, and which is therefore not communicated outside the trusted server 4.

Furthermore, the look-up tables S_{i,j} are precomputed so as to observe the constraints defined above. This precomputation is based on prior knowledge of the d secondary masks [symbol] r [symbol] ₁, . . . , [symbol] r [symbol] _{d}, which themselves derive from the primary mask r. The primary mask can also be generated by the processor 40 of the trusted server 4. The primary mask r can be generated by the function Funshade.Setup( ) described in Ibarrondo et al., Funshade: Functional Secret Sharing for Two-Party Secure Thresholded Distance Evaluation, Cryptology ePrint Archive, Paper 2022/1688, 2022.

### Enrollment

It is assumed that a reference individual to be enrolled arrives in the vicinity of the enrollment device 6. In practice, the reference individual may be an individual who has obtained the right to access the secure area discussed above. When the control device 1 is placed at an airport, the secure area may give access to an aircraft, in which case the right to access the secure area is conferred by a ticket assigned to the reference individual.

The biometric sensor 66 of the enrollment device 6 acquires a reference biometric datum yᵤ relating to the reference individual.

The processor 60 encrypts the reference biometric datum yᵤ using the encryption key pk, so as to obtain the cipher c_{y}_{ᵤ} of the biometric datum yᵤ. In particular, it is possible during this step to use an encryption according to the Brakerski-Fan-Vercauteren (BFV) scheme as described in Fan, Junfeng, and Frederik Vercauteren. “Somewhat practical fully homomorphic encryption.” Cryptology ePrint Archive (2012).

The cipher c_{y}_{ᵤ} is transmitted by the enrollment device 6 to the storage server 2 via the communication interface 62.

The storage server 2 receives the cipher c_{y}_{ᵤ} via its communication interface 22, and adds it to the database contained in its memory 24. The reference individual is then enrolled.

The above steps are repeated by the enrollment device 6 for multiple reference individuals to be enrolled, whereby the database contained in the memory 24 stores a plurality of ciphers, each cipher relating to a different reference individual. Each time, the same encryption key pk is used by the processor 60.

### Identity Check

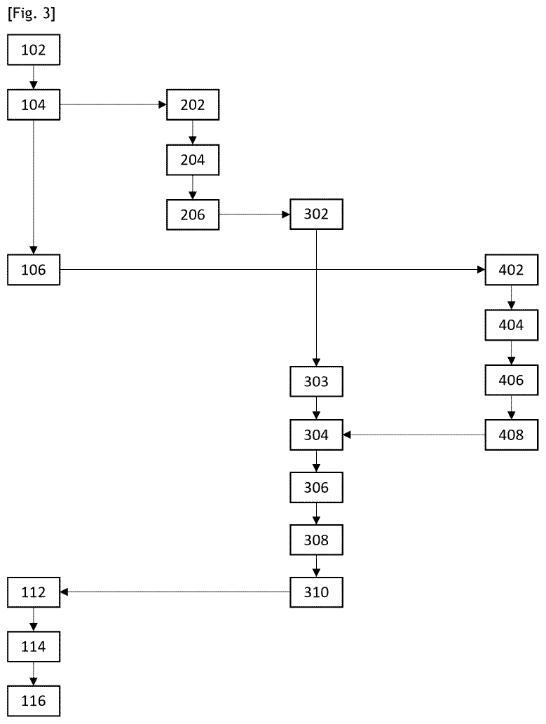

Referring to FIG. 3, a method performed by means of the system comprises the following steps. When it is mentioned hereinafter that the control device 1, a storage server 2, a decryption device 3 or the trusted server 4 implements a processing operation, it will be understood that this processing operation is more specifically performed by the corresponding processor 10, 20, 30, 40.

It is assumed that an individual whose identity needs to be checked arrives in the vicinity of the control device 1. For example, the individual to be checked arrives at a boarding gate of an airport where the control device 1 has been installed, wanting to board an aircraft.

In a step 102, the biometric sensor 16 acquires a biometric datum x relating to the individual to be checked. Hereinafter, this biometric datum x is called the “test biometric datum” in order to distinguish it from the reference biometric data discussed above, and the respective ciphers of which are stored by the storage server 2.

In a step 104, the control device 1 sends, for any j ranging from 1 to k, the test biometric datum x to the storage server 2 of index j via the communication interface 12. In other words, the k storage servers 2 receive the test biometric datum x.

Furthermore, in a step 106, the control device 1 sends the trusted server 4 a request associated with the test datum x.

Steps 104 and 106 can be carried out in any order.

In a step 202, the storage server 2 of index j receives the test biometric datum x via the communication interface 22.

In a step 204, the storage server 2 of index j determines, in the precomputed look-up table S_{i,j}, the term equal to (T_{i,j}(p_{i,j}, ref_{i,j})+ [symbol] r [symbol] _{i,j})mod 2ⁿ matching the pair consisting of the portion p_{i,j} of the test biometric datum x and the portion ref_{i,j} of the cipher c_{y}_{ᵤ} of the reference biometric datum.

During step 204, the storage server 2 of index j repeats this determination for any i ranging from 1 to d and therefore determines d terms S_{i,j}(p_{i,j}, ref_{i,j}) constituting d portions of the cipher c_{s+r.} of the score s masked by the primary mask r, each portion corresponding to a look-up table S_{i,j} and therefore to an encryption device 3.

This step 204 is fast to carry out because of the use of precomputed look-up tables S_{i,j}.

In a step 206, the storage server 2 of index j transmits the d terms S_{i,j}(p_{i,j}, ref_{i,j}) that it has determined to each of the d decryption devices 3. As each storage server 2 of index j comprises a look-up table S_{i,j} for each encryption device 3 of index i, there are therefore d×k look-up tables in total.

In a step 402, the trusted server 4 receives the request sent during step 106.

In a step 404, the trusted server 4 generates d secondary decryption keys [symbol] sk [symbol] ₁, . . . , [symbol] sk [symbol] _{d} stemming from the decryption key sk, or one for each encryption device 3.

In a step 406, the trusted server 4 generates d unmasking data k₁, . . . , k_{d} which are associated with the primary mask r.

Steps 404 and 406 can be performed in any order.

In a step 408 performed for any i ranging from 1 to d, the trusted server 4 transmits to the decryption device 3 of index i:
the secondary decryption key [symbol] sk [symbol] ᵢ of index i,
the unmasking datum kᵢ of index i.

On the other hand, any datum of index i generated by the trusted server 4 in steps 404, 406 is not sent to any decryption device 3 of index j other than i.

For any i ranging from 1 to d, the decryption device 3 of index i performs the following steps.

In a step 302, the decryption device 3 of index i receives the d×k terms S_{i,j}(p_{i,j}, ref_{i,j}), which have been sent to it by the k storage servers 2. It will be recalled that each storage server 2 polled provides d terms.

In a step 303, the decryption device 3 of index i computes the cipher c_{s+r.} of the masked score s+r. by summing the dk portions it received in step 302, as follows:

$${\sum }_{i = 1}^{d} {\sum }_{j = 1}^{k} {S}_{i , j}$$

Each of the d encryption devices 3 performs this operation. In a step 304, the decryption device 3 of index i receives:
the secondary decryption key [symbol] sk [symbol] ᵢ of index i,
the unmasking datum kᵢ of index i.

Steps 302 and 304 can occur in any order, depending on how the control device 1 operates.

In a step 306, the decryption device 3 of index i applies a decryption processing operation ColMaskDecr( ) to the cipher of the masked score, as described in Ibarrondo, Alberto, et al. “Colmade: Collaborative masking in auditable decryption for bfv-based homomorphic encryption.” Proceedings of the 2022 ACM Workshop on Information Hiding and Multimedia Security, 2022. This processing produces a datum s representing the score in a form decrypted using the primary decryption key, but still masked using the primary mask r. It can thus be noted that:

$$\hat{s} = ColMaskDecr ( {c}_{s + r .} , {〈 sk 〉}_{i} )$$

If the cipher cₛ were to be decrypted using the primary decryption key sk, what would be obtained is not the score s in plaintext form, but the score masked using the primary mask r. The decryption and masking processing ColMaskDecr( ) has the property of arriving at the datum ŝ without performing intermediate computation of the score s in plaintext form. This is because the cipher taken as input already relates to a masked score, and not to the score s in plaintext form.

A detailed description will now be given of an embodiment of the decryption and masking processing ColMaskDecr( ) In this embodiment, the cipher c_{s+r.} of the masked score is in the form of a pair of data cₛ_{ₐ}, cₛ_{_{b}}. These two data constitute two different portions of the cipher c_{s+r.}.

The decryption device 3 of index i computes an intermediate datum [symbol] c_{ŝ}_{_{b}} [symbol] ᵢ of index i from the following data: the part cₛ_{_{b}} of the cipher c_{s+r.}, the secondary decryption key [symbol] sk [symbol] ᵢ of index i, and a random quantity eᵢ generated by the device of index i.

This computation can be as follows:

$${〈 {c}_{{\hat{s}}_{b}} 〉}_{i} = {c}_{{s}_{b}} {〈 sk 〉}_{i} + {e}_{i}$$

The decryption device 3 of index i sends the intermediate datum [symbol] c_{ŝ}_{_{b}} [symbol] ᵢ of index i to any other decryption device 3 of index j≠i. Furthermore, the decryption device 3 of index i receives an intermediate datum [symbol] c_{ŝ}_{_{b}} [symbol] ⱼ of index j≠i produced by any other decryption device of index j≠i.

The decryption device 3 of index i computes the datum ŝ from the intermediate data [symbol] c_{ŝ}_{_{b}} [symbol] ₁, [symbol] c_{ŝ}_{_{b}} [symbol] ₂, and from the part cₛ_{_{d}} of the cipher cₛ. This computation can be performed as follows:

$${\hat{s} = [ ⌊ {\frac{t}{q} [ {c}_{{s}_{a}} + {\sum }_{i = 1}^{d} {〈 {c}_{{\hat{s}}_{b}} 〉}_{i} ]}_{q} ⌉ ]}_{t}$$

wherein
   [symbol] c_{ŝ}_{_{b}} [symbol] ᵢ is the intermediate datum of index i (computed or received),
   cₛ_{ₐ} is the second part of the cipher c_{s+r.},
   t and q are two integers constituting parameters of a Brakerski-Fan-Vercauteren encryption scheme,
   └ . . . ┐ signifies the modulo q operator,
   [ . . . ]_{q} signifies the operator for rounding to the nearest integer,
   [ . . . ]ₜ signifies the modulo t operator.

In this embodiment, it holds that:

$$\hat{s} ≡ s + r$$

In this equation, the sign ≡ represents an equality. Thus, the datum s turns out to be the masked score, that is to say the sum of the score s in plaintext form and the primary mask r.

In a step 308, the decryption device 3 of index i computes a partial result oᵢ of index i from the datum and the unmasking datum kᵢ of index i:

$${o}_{i} = FSS . eval ( \hat{s} , {k}_{i} )$$

Obtaining the partial result is described in Ibarrondo et al., Funshade: Functional Secret Sharing for Two-Party Secure Thresholded Distance Evaluation, Cryptology ePrint Archive, Paper 2022/1688, 2022. The acronym ‘FSS’ refers to the sharing of a secret function (“Function Secret Sharing”). In a step 310, the decryption device 3 of index i sends the partial result oᵢ to the control device 1.

The processing performed by the decryption device 3 of index i is finished.

As indicated above, the processing consisting of steps 302 to 310 is performed d times: once per decryption device of index i. Thus, d partial results o₁, . . . , o_{d} are generated.

The d-uplet of partial results o₁, . . . , o_{d} has the property of making it possible to compute a check result o indicating whether or not the test biometric datum x matches the reference biometric datum yᵤ. On the other hand, it is not possible to compute this check result on the basis of a subpart of this d-uplet.

In a step 112, the control device 1 receives the d partial results o₁, . . . , o_{d} respectively generated and sent by the d decryption devices 3.

In a step 114, the control device 1 computes the check result o from the d partial results o₁, . . . , o_{d} received. As indicated above, the check result indicates whether or not the test biometric datum x matches the reference biometric datum yᵤ.

In one embodiment, the check result o is obtained by summing the partial results, as follows:

$$o = {\sum }_{i = 1}^{d} {o}_{i}$$

The cryptographic processing operations jointly carried out by the d decryption devices 3 and the step of computing the check result o represent a comparison between a threshold and the distance between the test biometric datum x and the reference biometric datum yᵤ. The threshold is defined in the function FSS.Setup( ) used to generate the primary mask r, the secondary decryption keys and the unmasking data (the threshold is encoded by these data, as it were).

In practice, the check result o may be a Boolean.

If the check result o indicates that the test biometric datum x matches the reference biometric datum yᵤ, that is to say that the value of the check result o is equal to 1 (or ‘True’), then it is presumed that the individual to which the test biometric datum x relates has previously been enrolled with the server 2. Under these conditions, the processor 10 can open the gate 18 in a step 116 in order to allow the individual to access a secure area.

If the check result indicates that the test biometric datum x does not match the reference biometric datum yᵤ, that is to say that the value of the check result o is equal to 0 (or ‘False’), then it is presumed that the checked individual is not the reference individual to which the reference biometric datum yᵤ relates.

### Particular Embodiments

In one embodiment, k=1 is chosen. Thus, a single storage server 2 is called upon to produce portions of the cipher c_{s+r.} of the masked score.

The equations discussed above can be written more simply as follows:

$${c}_{s} = f ( x , {c}_{{y}_{u}} ) = {\sum }_{i = 1}^{d} {f}_{i} ( {p}_{i} , {ref}_{i} )$$

$${S}_{i} ( {p}_{i} , {ref}_{i} ) = ( {T}_{i , j} ( {p}_{i} , {ref}_{i} ) + {〈 r 〉}_{i , j} ) mod {2}^{n}$$

$${c}_{s + r .} \approx {\sum }_{i = 1}^{d} {S}_{i} ( {p}_{i} , {ref}_{i} )$$

Here, the single storage server 2 called upon single-handedly determines all the d portions Sᵢ(pᵢ, refᵢ) that can be used to find the cipher c_{s+r.} of the masked score.

Under these conditions, the storage server 2 can directly compute the cipher c_{s+r.} by summing the d portions Sᵢ(pᵢ, refᵢ), and then transmit this cipher to all the decryption devices 3, rather than letting each decryption device 3 perform this step (step 305 in the description above). Thus, a summation operation carried out d times in step 305 is performed only once here by the single storage server 2 polled.

In one embodiment, d=2 is chosen (possibly in combination with k=1). In this embodiment, two decryption devices 3 are involved. Two intermediate data [symbol] c_{ŝ}_{_{b}} [symbol] ₁, [symbol] c_{ŝ}_{_{b}} [symbol] ₂ are interchanged between the two decryption devices 3 of respective indices 1 and 2.

### Look-Up Table Optimizations S_{i,j}

Since the computations performed are reduced modulo 2ⁿ, a term S_{i,j}(p_{i,j}, ref_{i,j}) can have only one value from among a possible 2ⁿ.

In an advantageous embodiment, the look-up table S_{i,j} comprises two tables:
a first table that matches the pair p_{i,j}, ref_{i,j} to a pointer,
a second table of 2ⁿ terms, corresponding to the 2ⁿ values that each term S_{i,j}(p_{i,j}, ref_{i,j}) can take.

The pointer provided by the first table points to a position in the second table where the value of the sought term S_{i,j}(p_{i,j}, ref_{i,j}) is stored.

Thus, this term is determined in two stages: the storage server 2 first determines the pointer matched to the entry pair in the first table, then determines the term in the second table using the pointer of index i.

This breakdown into two tables has the advantage of drastically reducing the memory footprint of the look-up tables. The pointers constituting the output values of the first table are much more compact than the terms S_{i,j}(p_{i,j}, ref_{i,j}). For example, a pointer can simply take the form of a position index in the second table, so have an integer value between 0 and 2ⁿ−1. Thus, the first table comprises only compact output values, and the terms S_{i,j}(p_{i,j}, ref_{i,j}), the number of which is limited (2ⁿ), are delocalized in the second table, of limited length.

This allows the storage server of index i to use the following tables:
d first tables that each match the pair p_{i,j}, ref_{i,j} to a pointer,
a second common table “pointed at” by the above d pointers.

### Permutating the Look-Up Tables Before Repeating the Method

Thus far, an identification method based on a test biometric datum x has been described, to check the identity of an individual to whom this datum x relates. This method is intended to be repeated for multiple different test biometric data, which are likely to relate to different individuals.

Preferably, at least one of the following data is a single-use datum for the test biometric datum x, or even for the cipher c_{s+r.} of the masked score:
the unmasking datum of index i,
the secondary decryption key of index i.

These measures provide better protection for the system against replay attacks.

Another measure that makes it possible to achieve this objective of protection against replay attacks by means of very simple operations consists in permutating the second table, discussed above, before applying the steps of the method to a new test biometric datum x to be checked. By performing such permutation, the secondary masks [symbol] r [symbol] _{i,j} are “distributed” differently.

### OTHER EMBODIMENTS

One particular application of the identity checking method, in which the result of the check is a condition for accessing a secure area, has been discussed above. However, it will be understood that the described method may be used for other applications.

1. A method comprising steps of:
computing a cipher of a masked score, the masked score representing the result of applying a primary mask r to a score representing a distance between a test biometric datum (x) relating to an individual and a reference biometric datum (yᵤ), the computation comprising:
for any j ranging from 1 to k and for any i ranging from 1 to d, with k≥1 and d≥2, determining, in a precomputed look-up table, a term equal to (T_{i,j}+ [symbol] r [symbol] _{i,j})mod 2ⁿ matching a pair consisting of a portion of the test biometric datum (x) and a portion of a cipher (c_{y}_{ᵤ}) of the reference biometric datum, where:
the cipher of the reference biometric datum (c_{y}_{ᵤ}) results from an encryption of the reference biometric datum (yᵤ) using a primary encryption key (pk),
n is a predefined integer,
a sum
$$( {\sum }_{i = 1}^{d} {\sum }_{j = 1}^{k} {T}_{i , j} )$$
mod 2ⁿ of the tables T_{i,j} constitutes an estimate of a cipher of the score in unmasked form,
the primary mask r is connected to secondary masks [symbol] r [symbol] _{i,j} by the following relationship:
$$( {\sum }_{i = 1}^{d} {\sum }_{j = 1}^{k} {〈 r 〉}_{i , j} ) mod {2}^{n} = r mod {2}^{n} ,$$
performing the following summation in order to obtain the cipher of the masked score:
$${\sum }_{i = 1}^{d} {\sum }_{j = 1}^{k} ( {T}_{i , j} + {〈 r 〉}_{i , j} ) mod {2}^{n} ;$$
for any i ranging from 1 to d, performing the following steps by way of a decryption device of index i:
decrypting the cipher of the masked score using a secondary decryption key ( [symbol] sk [symbol] ᵢ) of index i, the decryption producing a datum (ŝ) representing the masked score modulo 2ⁿ,
generating a partial result (oᵢ) of index i from the datum (ŝ) and an unmasking datum (kᵢ) of index i,
wherein:
the secondary decryption keys ( [symbol] sk [symbol] ₁, . . . , [symbol] sk [symbol] _{d}) of respective indices ranging from 1 to d stem from a primary decryption key (sk) associated with the encryption key (pk),
the partial results (o₁, . . . , o_{d}) of respective indices ranging from 1 to d make it possible to compute a check result (o) indicating whether or not the test biometric datum (x) matches the reference biometric datum.

2. The method as claimed in claim 1, wherein determining the term (T_{i,j}+ [symbol] r [symbol] _{i,j}) mod 2ⁿ comprises the following steps:
determining, in a first look-up table of index i, a pointer of index i matching the pair, the pointer of index i pointing to a position, in a second table of 2ⁿ terms, where the term of index i is stored,
determining the term of index i in the second table using the pointer of index i.

3. The method as claimed in claim 2, additionally comprising steps of:
permutating the second table, then
repeating the computation of the cipher of the masked score for a new test biometric datum.

4. The method as claimed in claim 1, wherein:
$$k > 1 ,$$
for any j ranging from 1 to k and for any i ranging from 1 to d, the determination of the term equal to (T_{i,j}+ [symbol] r [symbol] _{i,j}) mod 2ⁿ is performed by a storage server of index j,
for any j ranging from 1 to k, the storage server of index j computes a portion of index j of the cipher of the masked score by way of the following summation:
$${\sum }_{i = 1}^{d} ( {T}_{i , j} + {〈 r 〉}_{i , j} ) mod {2}^{n} ,$$
for any i ranging from 1 to d, the decryption device of index i computes the cipher of the masked score by summing the portions of respective indices ranging from 1 to k of the cipher of the masked score.

5. The method as claimed in claim 1, wherein k=1 and the computation of the cipher of the masked score is performed by a single storage server.

6. The method as claimed in claim 1, wherein the decryption performed by the decryption device of index i comprises the following steps:
computing an intermediate datum ( [symbol] c_{ŝ}_{_{b}} [symbol] ᵢ) of index i from the following data:
a first part (cₛ_{_{b}}) of the cipher of the masked score,
the secondary decryption key ( [symbol] sk [symbol] ᵢ) of index i, and
a random quantity (eᵢ) generated by the decryption device of index i,
for any decryption device of index j≠i, receiving an intermediate datum ( [symbol] c_{ŝ}_{_{b}} [symbol] ⱼ) of index j sent by the decryption device of index j,
computing the datum (ŝ) representing the masked score from the following data:
the intermediate data ( [symbol] c_{ŝ}_{_{b}} [symbol] ₁, . . . , ( [symbol] c_{ŝ}_{_{b}} [symbol] _{d}) of respective indices ranging from 1 to d,
a second part (cₛ_{ₐ}) of the cipher of the masked score.

7. The method as claimed in claim 6, wherein the intermediate datum [symbol] c_{ŝ}_{_{b}} [symbol] ᵢ of index i is computed as follows [symbol] c_{ŝ}_{_{b}} [symbol] ᵢ=cₛ_{_{b}} [symbol] sk [symbol] ᵢ+eᵢ, wherein
cₛ_{_{b}} is the first part of the cipher (cₛ) of the masked score, [symbol]
sk [symbol] ᵢ is the secondary decryption key of index i,
eᵢ is the random quantity generated by the device of index i.

8. The method as claimed in claim 6, wherein the datum (ŝ) representing the masked score modulo 2ⁿ is computed as follows:
$${\hat{s} = [ ⌊ {\frac{t}{q} [ {c}_{{s}_{a}} + {\sum }_{i = 1}^{d} {〈 {c}_{{\hat{s}}_{b}} 〉}_{i} ]}_{q} ⌉ ]}_{t} mod {2}^{n}$$
wherein [symbol]
c_{ŝ}_{_{b}} [symbol] ᵢ is the intermediate datum of index i,
cₛ_{ₐ} is the second part of the cipher (cₛ) of the score,
t and q are two integers constituting parameters of a Brakerski/Fan-Vercauteren encryption scheme,
└·┐ signifies the operator for rounding to the nearest integer,
[·]_{q} signifies the modulo q operator,
[·]ₜ signifies the modulo t operator.

9. The method as claimed in claim 1, wherein the check result (o) is equal to the sum of the partial results (o₁, . . . , o_{d}) of respective indices ranging from 1 to d.

10. The method as claimed in claim 1, wherein at least one of the following data is a single-use datum for the test biometric datum (x), or even for the cipher of the masked score:
the unmasking datum of index i,
the secondary decryption key of index i.

11. A computer program product comprising program code instructions for carrying out the steps of the method as claimed in claim 1 when this program is executed by a system.

12. A computer-readable memory storing instructions that are executable in order to carry out the steps of the method as claimed in claim 1.

13. A system comprising a control device, a storage server, at least two decryption devices, a trusted server and an enrollment device, wherein said devices and servers include processors configured to perform the steps of the method as claimed in claim 1.

14. A method for controlling access by an individual to a secure area, comprising performing the steps of the method as claimed in claim 1 in order to identify the individual.
